(19) United States
(12) Patent Application Publication
(10) Pub. No.: US 2002/0165643 A1
(43) Pub. Date: Nov. 7, 2002

(54) Retail robot time share system

(76) Inventors: Allen John Bancroft, Richmond, VA (US); Charles W. Ward, Richmond, VA (US); Stephen A. Storey, Richmond, VA (US)

Correspondence Address: J. Michael Martinez de Andino, Esq., HUNTON & WILLIAMS, Riverfront Plaza, East Tower, 951 East Byrd Street, Richmond, VA, 23219-4074, US

(21) Appl. No.: 10/139,717

(22) Filed: May 6, 2002

Related U.S. Application Data
(60) Provisional application No. 60/288,711, filed on May 4, 2001.

(51) Int. Cl. G05B 19/04

(52) U.S. Cl. 700/245; 700/247

(57) ABSTRACT

A method of utilizing a robot system, the method comprising the steps of offering for consideration a usage unit for the robot system, accepting an order for the usage unit, and performing a retail function by the robot system for the duration of the usage unit.

This application claims priority of U.S. Provisional Application No. 60/288,711, filed on May 4, 2001, which is incorporated herein by reference in its entirety.

### FIELD OF THE INVENTION

The system and methods of the invention relate to utilizing a retail robot in a robot time share system.

### BACKGROUND OF THE INVENTION

The marketing and advertising industry spends billions of dollars each year targeting consumers with the goal of delivering an advertising message that the consumer will remember in the local retail establishment. Advertisements bombard consumers everyday through the use of several advertising mediums. Consumers hear and see product advertisements through television commercials, radio messages, newspaper and magazine ads, and direct mailings. However, not all advertisements achieve their purpose. An advertisement must be well-received by a consumer, but also memorable enough to create an impression that the consumer will carry into the local retailer. For at least these reasons, product manufacturers are continuously seeking new and improved ways for presenting advertising and marketing messages to the consumer.

To this end, advertising and corporate executives continuously create methods for assessing the revenue generated through each advertising medium. The decision makers analyze the value of each type of advertising and determine the most cost-efficient mediums for spending those precious advertising resources.

Accordingly, there is a need for an efficient and effective system and method for addressing these problems and others with respect to the utilization of robot systems over a robot network.

### BRIEF SUMMARY OF THE INVENTION

In accordance with one embodiment, the invention provides a method of utilizing a robot system, the method comprising the steps of offering for consideration a usage unit for the robot system, accepting an order for the usage unit, and performing a retail function by the robot system for the duration of the usage unit, for example.

In accordance with another embodiment, the invention provides a method of presenting an advertising message over a robot network comprising the steps of accessing a management system for the robot network, selecting a usage unit for a robot system having a set of robot parameters, and transmitting an order for the usage unit to the management system, the order including data indicating assent to purchase the usage unit and control data for presenting the advertising message on the robot system, for example.

In accordance with yet another embodiment, a retail robot time share system is disclosed. The time share system comprises a central management system offering for consideration a usage unit for a robot system and a user system transmitting an order for the usage unit to the central management system, the order including a user selected retail function. Once the central management system receives the order, it delivers a command to the robot system to perform a the user selected retail function.

### BRIEF DESCRIPTION OF THE DRAWINGS

The present invention can be more fully understood by reading the following detailed description of the presently preferred embodiments together with the accompanying drawings, in which like reference indicators are used to designate like elements, and in which:

FIG. 1 is a flowchart showing a method of utilizing a robot system in accordance with an embodiment of the method and system of the invention;

FIG. 2 is a flowchart showing the illustrative offer step of FIG. 1 in further detail in accordance with an embodiment of the method and system of the invention;

FIG. 3 is a flowchart showing the illustrative acceptance step of FIG. 1 in further detail in accordance with one embodiment of the method and system of the invention;

FIG. 4 is a flowchart showing the illustrative performance step of FIG. 1 in further detail in accordance with yet another embodiment of the method and system of the invention; and

FIG. 5 is an illustrative robot network system in accordance with one embodiment of the system and method of the invention.

### DETAILED DESCRIPTION OF THE INVENTION

In accordance with one embodiment, the invention provides a method of utilizing a robot system, the method comprising the steps of offering for consideration a usage unit for the robot system, accepting an order for the usage unit, and performing a retail function by the robot system for the duration of the usage unit.

In accordance with another embodiment, the invention provides a method of presenting an advertising message over a robot network comprising the steps of accessing a management system for the robot network, selecting a usage unit for a robot system having a set of robot parameters, and transmitting an order for the usage unit to the management system, the order including data indicating assent to purchase the usage unit and control data for presenting the advertising message on the robot system.

Further details of the systems and methods of the invention will hereinafter be described. As used herein, items referred to in the singular may also be in the plural, and items referred to in the plural may also be in the singular.

As used herein, a “robot” or “robot system” is a stand-alone system, for example, that is mobile, that performs both physical activities and computational activities. The physical activities may be performed using a wide variety of movable parts including interactive devices, user interfaces, and other devices, for example. The computational activities may be performed utilizing a suitable processor and memory stores, i.e., a data memory storage device, for example. The computational activities may include processing information input from various sensors or other inputs of the robot system to perform commanded functions; processing the input information, as well as other data in the memory stores of the robot system, to generate a variety of desired information; or outputting information that has been acquired or produced by the robot system to a desired destination, for example.

As used herein, the term “retail” or “retail environment” is defined as activity relating to, but not limited to, the sale of goods or commodities or any other items, or providing any type of services, for example, to a person, such as in store, in a circus, a factory, warehouse, shop, mall, fair, outside market, display area, hospital, law firm, accounting firm, restaurant, commercial office space, convention center, hotel, airport, arena, stadium, outdoor venue or any other area either inside a structure or outside in which goods, commodities or services are provided, manufactured, stored, sold, offered for sale, displayed in anticipation of future sales, or displayed, such as for any type of promotional activities, for example.

As used herein, a “customer” is a person, or a device acting on behalf of a person, who buys, leases, or otherwise acquires or deals with goods, commodities, or services in a retail environment, or who is interested in discussing or viewing goods, commodities, or services in retail environment, for example.

Methods for Utilizing the Time Share System

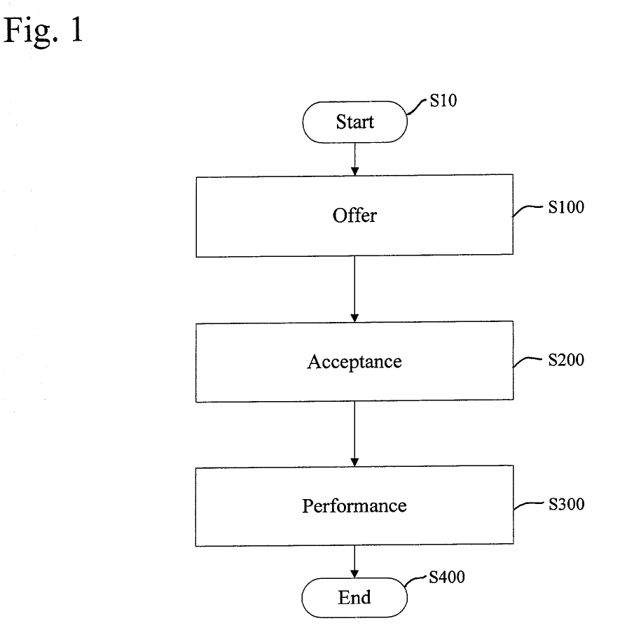

FIG. 1 is a method of utilizing a robot system in accordance with one embodiment of the system and method of the invention. When viewed as a transaction for the usage of a robot system, the process begins in step S10 and includes three main steps. In step S100, an offer is made. The offer comprises an offer to purchase the utilization of a robot system to perform a retail function. Each offer is conditioned or defined by a certain unit of robot usage. These usage units may be defined comprised of a certain amount of time, number of completed transactions, number of customer interactions, or other quantities.

An illustrative customer interaction may include a customer approaching the robot system and asking for the location or price of a particular product being advertised. Also, the customer may inquire whether the retailer has the product in stock. A typical robot system response to the customer interaction may incorporate providing the location of the product by showing a map, printing a map, directing the customer to the actual product, having the customer follow the robot system to the product's location, or directly selling the product to the customer, for example.

In step S200, a consumer accepts an offer. Once the user accepts the offer, the robot system performs a retail function purchased by the consumer, in step S300. After the robot system performs the retail function that was the subject of the offer and acceptance, the process ends in step S400. Essentially, the above-described method comprises a transaction for the use of a robot system to perform a retail function. The user may be a product manufacturer, a retailer, a vendor, or preferably, an advertising or marketing company entrusted to enact the marketing strategy for a large manufacturer. Although the versatility of the robot system allows a broad range of available retail functions, the robot systems may be utilized in the retail environment to target consumers at the point of purchase.

It should be appreciated that the robot system may be used to facilitate a retail environment by performing several additional retail functions and tasks. In accordance with the method and system of the invention, these functions or tasks may include performing advertising functions, marketing and analysis, customer relations and interaction, maintenance and monitoring of the retail environment, maintenance and assessment of the retail robot itself, monitoring and implementation of remotely-commanded tasks, serving as mobile kiosks, serving in a time-share advertising and marketing system for customer interaction, for example.

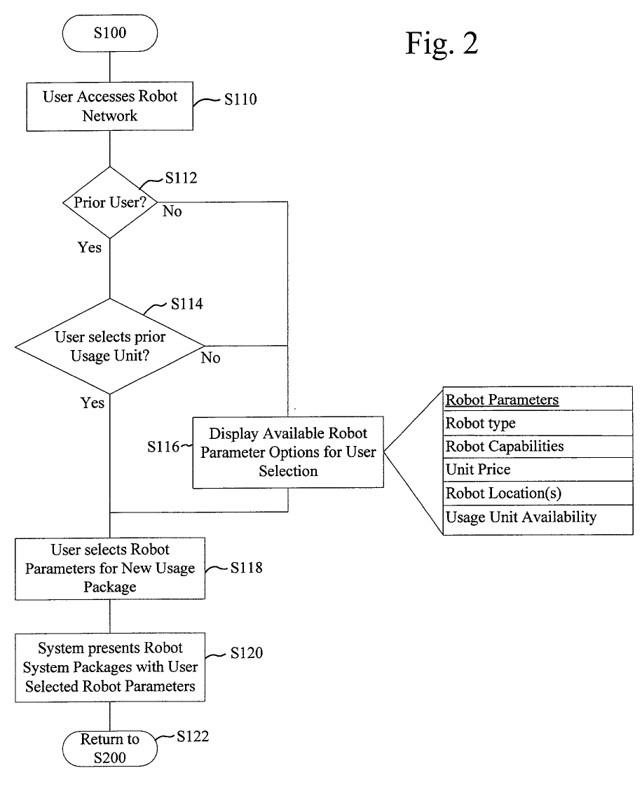

FIG. 2 is a flowchart showing the illustrative offer step of FIG. 1 in further detail in accordance with an embodiment of the method and system of the invention. The process begins in step S100 and then passes to step S110, wherein a user accesses a central management system of a retail robot network. The user may access the retail robot network through the central management system via any suitable communication interface, modem, telephone, fax, or other computer connection, data input to an IP address given to the central management system, or any other suitable connection through which the central management system's processor might receive input from the user or user's system. The system may also utilize various authentication and authorization methods to verify the identity of a user before access is granted to the retail robot network. For example, the user may be required to provide a user ID and password before access is granted.

Once the user has accessed the retail robot network, the process passes to step S112. In step S112, the central management system determines whether the user has previously accessed the network. The central management system does so by analyzing user information entered to access the retail robot network. For example, the central management system may track users through information such as user ID, vendor ID, or account ID. If the user has previously accessed the network, the process passes to step S114. For users that have not previously accessed the network, the process passes to step S116.

For prior users, in step S114, the central management system presents the user with the ability to select previously selected robot system packages, i.e., a combination of various robot system usage units, along with the option of choosing new robot usage parameters to create a new robot system package. To provide further understanding, the prior user is presented with previously utilized packages that were used to employ certain robot systems in certain locations at certain time periods during the day. In essence, the user may select a recurring advertising routine or package without having to reprogram a fleet of robots to deliver an existing advertising routine.

For new users, however, in steps S116, the central management system presents only the new robot usage parameters for the selection and creation of a new robot system package for the new user. Once the user is presented with the various robot system usage options in steps S114 and S116, the process passes to step S118. In step S118, the user selects robot parameters for determining available robot systems having the user selected parameters. As stated above, the user selected robot parameters may include a previously utilized robot system package for prior users, or newly created package for new users. Then, in step S120, the central management system presents the user with robot systems having the user selected robot parameters. In essence, the user is presented with the option to purchase a unit of usage for the robot systems meeting the user's defined criteria (i.e., by store location, by retail chain, etc.). To complete the offer for the unit of usage requires that the system present the user with cost information as well as the periods of availability for each robot system presented. It should be appreciated that the user may be presented with several options, or robot systems, meeting the selected criteria, i.e., robot parameters. The display also allows the user to compare the price of each robot system meeting the selected criteria. If too many robot system packages are presented to the user, the user may edit the selected robot parameters to narrow the available options. Finally, in step S122, the process returns to step S200.

It should be appreciated that when the user accesses the system, the user is presented with the option of selecting various robot system parameters to determine the availability of robot systems in the retail robot network. In one embodiment of the invention, robot system parameters may include robot type, robot capabilities, unit price, robot location (by store, by retail chain, by state, by region, etc.), robot availability for each usage unit. The usage units may be defined by a period of time (minutes, hours, days, mornings, afternoons, evenings, holidays, weekends), number of interactions (by customer, by sale), or any combination of usage criteria, for example. Thus, through the selection of the robot system parameters and available usage units, the user can customize an advertising or marketing strategy that targets consumers at the point of purchase.

It should be further appreciated that the central management system may be a computer operating system that performs computational functions. The computational functions may be performed utilizing a suitable processor, server and memory stores, i.e. a data memory storage device, for example. The computational functions may include processing input and information from users of the retail robot network to allow access to the robot network; processing input and information, as well as other data in the memory stores of the central management system, to present usage options for users on various interfaces with users of the robot network system; or delivering commands to robot systems in the retail robot network, for example.

Additionally, in accordance with one embodiment of the system and method of the invention, the central management system may take the form a computer operating system managing a relational database. A relational database system allows information contained in different tables to be accessed and shared, while also providing the additional advantage that changes to data contained in one table of a relational database affects the same data in any other table sharing the same data. To provide further understanding, a table is a collection of several data records with similar data information fields. Data records represent a collection of data that is organized into fields. These fields may also be formatted to receive data of varying types such as alphanumeric, numeric or simple characters, for example. Accordingly, the database user can view data records in a user interface, input or edit the data contained in the various fields, or issue a database query that retrieves and reports information from multiple tables. Therefore, the system can maintain information on the availability of all robot systems in the network, various user's preferred packages or usage units, special offers, etc.

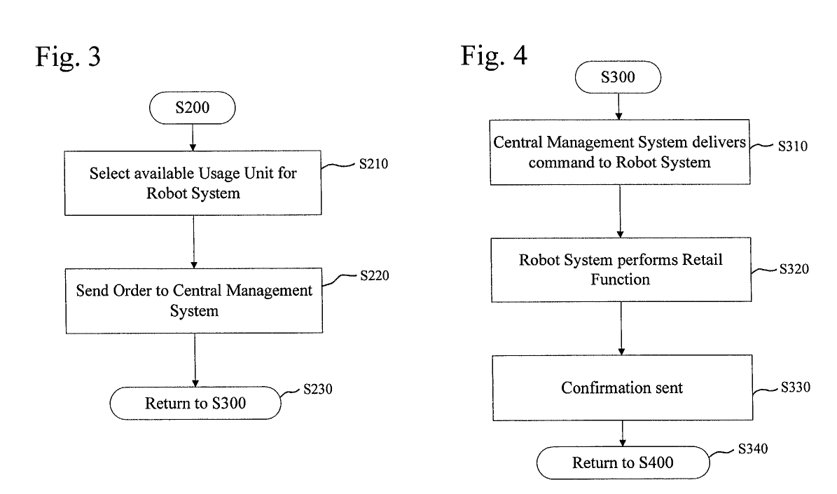

FIG. 3 is a flowchart showing the illustrative acceptance step of FIG. 1 in further detail in accordance with one embodiment of the method and system of the invention. The process begins with step S200 and passes to step S210, wherein the user selects a usage unit, or package, for a robot system. Then, in step S220, the user transmits an order to the central management system for the selected usage unit. Finally, in step S230, the process passes to step S300.

The user's order transmitted to the central management system indicates the user's assent to purchase at least one usage unit for the selected robot system. For those embodiments of the invention performing advertising and marketing functions, the user's order must provide the content data that will be delivered through the robot system. For prior users, the order need not include the actual content data as long as it directs the central management system to the storage location of reused content data.

FIG. 4 is a flowchart showing the illustrative performance step of FIG. 1 in further detail in accordance with yet another embodiment of the method and system of the invention. The process begins with step S300 and passes to step S310, wherein the central management system delivers a command to the robot system instructing the robot system to perform the retail function for which the user transmitted the order.

It should be appreciated that the robot systems of the invention may receive commands from the central management system via any suitable communication interface, modem, telephone, fax, wireless or other computer connection, such as the receipt of data input delivered to an IP address assigned to the robot system, or any other suitable connection through which the robot system's processor might receive input from an external source in the network.

Then, in step S320, the robot system performs a retail function for the duration of the usage unit. Once the usage unit is exhausted, in step S330, the central management system transmits a message to the user confirming that the robot system performed its commanded function.

Robot Network

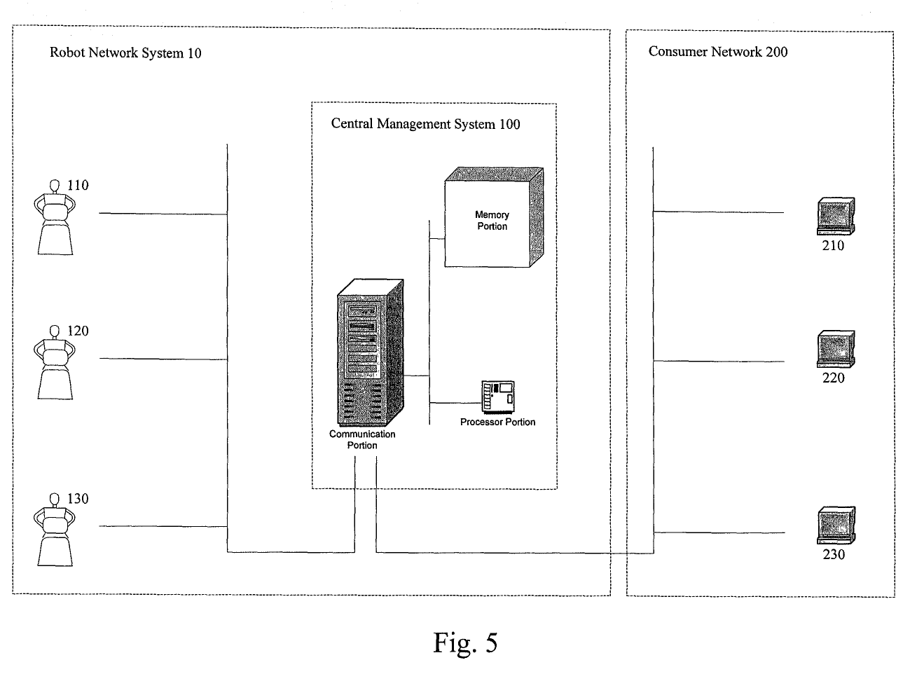

The above-described methods may be implemented using several network designs without deviating from the scope of the invention. Illustratively, FIG. 5 is a robot network system in accordance with one embodiment of the system and method of the invention. The robot network system 10 includes a central management system 100. The central management system 100 is responsible for offering the use of a plurality of robot systems 110, 120, and 130, over a consumer network 200. The central management system 100 maintains data on the availability of each robot system 110, 120 and 130, in the robot network system 10. The consumer network 200 includes a plurality of vendor systems 210, 220 and 230, that may access the robot network system 10.

To illustrate one embodiment of the invention, when vendor 210 wants to accesses the robot network system 10 and obtain the use of a robot system, the vendor 210 connects to the central management system 100. The applicant can access the robot network system in any suitable manner which allows the user to provide input to the central management system. Accordingly, any communication link established between the user and the central management system is suitable. For example, the user may utilize a computer operating system to establish a connection to the Internet where she can view a web page administered by the central management system. The user must then log into the system by providing an input that identifies the user, i.e. a user name and an associated user name password. Once logged on, the system displays a user interface to the user.

The central management system 100 presents the user with a user interface that allows the vendor 210 to select from a variety of robot system packages that may be acquired. If the vendor 210 has previously accessed the robot network system 10, the vendor 210 is presented with the option of selecting a previously selected robot system usage to determine its availability.

It should be appreciated that the retail robot network may include several networked robot systems throughout an area. This may represent a fleet of robot systems deployed in various retail environments throughout the United States. In one embodiment, each robot system includes an IP address through which it can receive commands from the central management system of the retail robot network. Robot systems may be grouped in IP address groups such that commands can be sent to several robot systems at one time.

Furthermore, in another embodiment of the invention, the entire retail robot network may be managed by an advertising or marketing company in one embodiment of the invention. Illustratively, a fleet of robot systems may be deployed in various retail environments across a geographic region. Control of the robot systems is delegated to the advertising company to ensure that the usage of each robot system is maximized. The advertising company maintains contact with product manufacturers and also the fleet of robot systems. In such an embodiment, the users may be individual representatives that work within the advertising company, connected via a company network to the central management system.

Hereinafter additional features in accordance with further embodiments of the method and system of the invention will be described. It should be appreciated that the various features and embodiments described herein may be utilized in combination with a variety of known technology. For example, the above features and embodiments may be used in conjunction with the features described in U.S. Pat. No. 5,548,511, which is incorporated herein by reference in its entirety, and U.S. Pat. No. 6,124,694, which is incorporated herein by reference in its entirety. Further, it should be appreciated that the various embodiments and features described herein may be used in conjunction with features in U.S. patent application Ser. No. 09/906,216, directed to system for a retail environment, U.S. patent application Ser. No. 09/906,159, directed to methods for facilitating a retail environment, U.S. patent application Ser. No. 09/928,669, directed to robot mapping systems, and U.S. patent application Ser. No. 09/976,420, directed to a robot touch shield, each of which are incorporated herein by reference in their entirety.

As described above, it should be appreciated that the retail robot, or robot system, may be utilized in various marketing and advertising systems which stand to maximize the profit center that is the retail robot. For example, a robot may be provided to a retailer for use in the retail environment. In the retail environment, the robot can have many uses, including acting as a communications medium between customers in the retail environment and those targeting the business of the customers. The retail robots may be sold to retailers, manufacturers, marketing and advertising agencies, and other retail-related service providers, such that the owner of the retail robot would be able to sell or lease operation of the retail robot in the retail environment.

For example, a grocer could own a robot, but when the robot was not performing a retail function such greeting customers, the grocer could lease the robot's downtime to a marketing agency or product manufacturer that could remotely command the robot around the retail environment to observe and interact with customers to obtain information. The robot provides a medium for obtaining information for marketing agencies and advertisers. The method of selling time in commanding the robot provides a further profit center to the robot owner, that maximizes the robot's downtime.

It should also be appreciated that one robot might communicate with multiple other robots. For example, one robot, while busy performing one function, might be commanded to perform a second function. As a result, that robot might communicate with a fleet of robots in the area to determine which robot in the fleet is available to perform the second function. As noted above, a gateway might be utilized to route communication between the robots. The gateway might be characterized as a traffic controller or a coordinator between the various robots.

In addition, a robot system may receive a command from another robot to perform a function or function task. As such, if a fleet of robots were deployed in an area, and one robot was given a function or function task that it could not address at that time, the robot could send a command to another robot, through any suitable interface, to perform the necessary function or task. Accordingly, an illustrative fleet of robots may take commands from a manager robot dispatching commands through interfaces with the other robots in the area.

It should further be appreciated that the robot system's ability to perform functions in an area may extend to those periods of time when no operators are present to supervise the robot system. As such, the robot system could perform a maintenance and security function, as well as a conventional cleaning function. In addition, the robot may be programmed to handle certain emergency situations, including for example, fire emergencies, burglaries or loss of power in the area in which it is operating. It should be appreciated that once the robot system detects an emergency condition, the robot system may alert all necessary personnel to the emergency condition.

It should be further understood that in accordance with the robot system's ability to operate autonomously the robot will be provided with the necessary programming, tasking and commands to ensure its readiness to perform functions in an area. This may require that the robot system monitor its own diagnostic system, including its power status and internal components, such that the robot system would understand if it needs to be recharged or serviced to maintain its working condition. Then, the robot system may alert the necessary personnel that it needs service. For simple service requirements, like the recharging of the robot system's batteries, dumping or refilling tanks, the robot system may deliver itself to a recharging station where it can autonomously recharge its batteries.

As used herein, the terms “robot system” and “network system” are to be understood to include at least one processor utilizing a memory or memories. The memory stores at least portions of an executable program code at one time or another during operation of the processor. Additionally, the processor executes various instructions included in that executable program code. An executable program code means a program in machine language or other language that is able to run in a particular computer system environment to perform a particular task. The executable program code processes data in response to commands by a user. As used herein, it will be appreciated that the term “executable program code” and term “software” mean substantially the same thing for the purposes of the description as used herein.

Further, it is to be appreciated that to practice the system and method of the invention, it is not necessary that the processor, or subportions of the processor, and/or the memory, or subportions of the memory be physically located in the same place or disposed in the same physical portion of the robot network system 10. That is, it should be appreciated that the processor and the memory may be located in geographically distinct locations and connected so as to communicate in any suitable manner, such as over a wireless communication path, for example. Additionally, it should be appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, each respective portion of the memory described above may include two or more portions of memory in two or more physical locations. Further, the memory could include or utilize memory stores from the Internet, Intranet, Extranet, LAN or some other source or over some other network, as may be necessary or desired.

As described above, the invention may illustratively be embodied in the form of a computer or computer operating system. It is to be appreciated that the software that enables the computer operating system to perform the operations described above may be supplied on any of a wide variety of data holding media. Further, it should be appreciated that the implementation and operation of the invention may be in the form of computer code written in any suitable programming language, which provide instructions to the computer.

It should further be appreciated that the software code or programming language that is utilized in a computer system to perform the various operations of the above described invention may be provided in any of a wide variety of forms. Illustratively, the software may be provided in the form of machine language, assembly code, object code, or source language, as well as in other forms. Further, the software may be in the form of compressed or encrypted data utilizing an encryption algorithm.

Additionally, it should be appreciated that the particular medium utilized may take on any of a variety of physical forms. Illustratively, the medium may be in the form of a compact disk, a DVD, an integrated circuit, a hard disk, a floppy diskette, a magnetic tape, a RAM, a ROM, or a remote transmission, as well as any other medium or source of information that may be read by a computer or other operating system.

Accordingly, the software of the method of the invention, which is utilized in operation of the robot network system 10, may be provided in the form of a hard disk or be transmitted in some form using a direct wireless telephone connection, the Internet, an Intranet, Ethernet, or a satellite transmission, for example. Further, the programming language enabling the system and method of the invention as described above may be utilized on all of the foregoing and any other medium by which software or executable program code may be communicated to and utilized by a computer or other operating system.

As described herein, the system and method of the invention may utilize an application program, a collection of separate application programs, a module of a program that is designed to handle, or a portion of a module of a program, for example. As noted above, it should be appreciated that the computer language used in the system and method of the invention may be any of a wide variety of programming languages. Further, it is not necessary that a single programming language be utilized in conjunction with the operation of the system and method of the invention. Rather, any number of different programming languages may be utilized as is necessary or desirable.

As described above, in the system and method of the invention, a variety of user interfaces are utilized. A user interface may be in the form of a dialogue screen for example. As used herein, a user interface includes any software, hardware or combination of hardware and software used in an operating system that allows a user to interact with the operating system. A user interface may include any of a touch screen, keyboard, mouse, voice reader, voice recognizer, dialogue screen, menu box, a list, a checkbox, a toggle switch, a pushbutton or any other object that allows a user to receive information regarding the operation of the program and/or provide the operating system with information. Accordingly, the user interface is any device that provides communication between a user and a computer. The information provided by the user to the computer through the user interface may be in the form of a command, a selection or data, or other input, for example.

A user interface is utilized by an operating system running an application program to process data for a user. As should be appreciated, a user interface is typically used by a computer for interacting with a user either to convey information or receive information. However, it should be appreciated that in accordance with the system and method of the invention, it is not necessary that a human user actually interact with a user interface generated by the operating system of the invention. Rather, it is contemplated that the user interface of the invention interact, i.e., convey and receive information, in communication with another operating system or computer, rather than a human user. Further, it is contemplated that the user interfaces utilized in the system and method of the invention may interact partially with another operating system while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its preferred embodiment, it is to be understood that this disclosure is only illustrative and exemplary of the present invention and is made merely for the purposes of providing a full and enabling disclosure of the invention. Many modifications to the embodiments described above can be made without departing from the spirit and scope of the invention. Accordingly, the foregoing disclosure is not intended to be construed or to limit the present invention or otherwise to exclude any other such embodiments, adaptations, variations, modifications and equivalent arrangements.

What is claimed is:

1. A method of utilizing a robot system comprising:
offering for consideration a usage unit for the robot system;
accepting an order for the usage unit; and
performing a retail function by the robot system for the duration of the usage unit.

2. The method of claim 1 wherein the robot system is a retail robot.

3. The method of claim 1 wherein offering for consideration the usage unit for the robot system comprises:
accessing by a user a robot network;
accepting a first robot parameter selected by the user; and
displaying a robot package describing a robot system having the first robot parameter and at least one available usage unit.

4. The method of claim 3 wherein the first robot parameter includes at least one of a robot system identifier, a robot system location identifier, a robot system function identifier, a robot system unit price and a robot system availability indicator.

5. The method of claim 3 wherein the robot package comprises the robot system identifier, at least one robot system location identifier, at least one robot system function identifier, the robot system unit price and at least one available usage unit for the robot system.

6. The method of claim 1 wherein the order for the usage unit comprises:
data indicating user assent to obtain the usage unit for consideration; and
retail function command data.

7. The method of claim 6 wherein the retail function command data includes advertising data for delivery through the robot system.

8. A method of presenting an advertising message over a robot network comprising:
accessing a management system for the robot network;
selecting a usage unit for a robot system having a set of robot parameters; and
transmitting an order for the usage unit to the management system, the order including data indicating assent to purchase the usage unit and control data for presenting the advertising message on the robot system.

9. A retail robot time share system comprising:
a central management system offering for consideration a usage unit for a robot system;
a user system transmitting an order for the usage unit to the central management system, the order including a user selected retail function,
wherein upon receipt of the order, the central management system delivers a command to the robot system to perform a the user selected retail function.

10. The system of claim 9 wherein the usage unit is a predetermined number of hours of robot system operation.

11. The system of claim 9 wherein the usage unit is a predetermined number of robot system interactions.
